(19) United States
(12) Patent Application Publication
(10) Pub. No.: US 2020/0061963 A1
(43) Pub. Date: Feb. 27, 2020

(54) TRIM COMPONENT FOR COVERING AN INTERIOR SPACE OF A MEANS FOR TRANSPORTING PASSENGERS AS WELL AS METHOD FOR PRODUCING SUCH A TRIM COMPONENT

(71) Applicant: MOTHERSON INNOVATIONS COMPANY LIMITED, London (GB)

(72) Inventors: PIERRE PIGNARD, JEBSHEIM (FR); YANN BUCHET, STRASBOURG (FR)

(73) Assignee: MOTHERSON INNOVATIONS COMPANY LIMITED, London (GB)

(21) Appl. No.: 16/516,391

(22) Filed: Jul. 19, 2019

(30) Foreign Application Priority Data
Aug. 23, 2018 (EP) 18 190 477.2

(51) Int. Cl. B32B 5/18; B29C 48/00; B60R 21/04; B60N 3/04; B60R 13/02

(52) U.S. Cl. CPC B32B 5/18; B29C 48/0017; B29K 2023/12; B60N 3/048; B60R 13/02; B60R 21/04

(57) ABSTRACT

The present invention relates to a trim component for covering an interior space of a means for transporting passengers, in particular a vehicle, wherein the trim component includes a compressed natural fiber composite element with at least one side that is visible from the interior space of the means for transporting passengers and that forms a natural fiber surface with a structure of natural fibers, and a protective varnish layer applied onto the natural fiber surface and surrounding the natural fibers, with the protective varnish layer being designed such that the structure of natural fibers can be felt. Furthermore, the invention relates to a method for producing such a trim component and a means for transporting passengers having such a trim component.

### CROSS-REFERENCES TO RELATED APPLICATIONS

This application claims the priority of European Patent Application Serial No. EP 18 190 477.2, filed Aug. 23, 2018, pursuant to 35 U.S.C. 119(a)-(d), the subject matter of which is incorporated herein by reference.

### BACKGROUND OF THE INVENTION

The present invention relates to a trim component for covering an interior space of a vehicle for transporting passengers and a method for producing such a trim component and the use of a trim component in a vehicle.

The term passenger vehicle is used here in its widest sense constructed, in particular, as a car, but can also be a ship, an airplane, a train or the like. When in the following, the invention is explained in terms of vehicles, the description extends likewise also to other means for transporting passengers such as ships, airplanes, trains and the like.

In all embodiments of the means for transporting passengers, the interior space is covered more or less elaborately to provide a corresponding design of the interior space. The design of the interior space plays an important role especially for motor vehicles and is an important selling point. Trim components are used for the trim of the interior space and cover, for example, the doors of the vehicle from the inside. The trim components can also form or be part of the instrument panel or of the trunk or of the side panel coverings.

For various reasons, among others for aesthetic or ecological reasons, it may be desirable to provide the visible side, i.e. the side which is perceivable and particularly visible and tangible from the interior of the means for transporting passengers, with a natural fiber surface with a structure made of natural fibers. However, natural fibers have compared to in particular synthetic fibers and other surface structures used for trim components a reduced resistance to physical, chemical and mechanical effects such as UV rays, scratches or abrasion. In addition, natural fibers are usually not water-repellent, so that the drying process after becoming wet takes a long time and often leaves water stains. In addition, wetting may cause mold formation and can change the surface properties.

EP 2 563 570 B1 discloses a trim component whose visible side is provided with a natural fiber surface with a structure made of natural fibers. In order to protect the natural fibers for the reasons mentioned above, a multilayer protective layer is used, wherein the protective layer is fabricated of the same material as the binding matrix for the natural fibers. The protective layer is heated and melted together with the natural fibers. However, this manufacturing process is complicated and expensive. The optical homogeneity of the natural fiber surface depends on several factors, including the material homogeneity of the natural fiber composite element, the homogeneity of the temperature distribution, the local material density, and the ability for local impregnation of the material.

### SUMMARY OF THE INVENTION

It is an object of an embodiment of the present invention to provide a trim component for covering an interior space of a means for transporting passengers which makes it possible using simple and inexpensive means to produce the natural fiber surface of the visible side of a trim component so that the natural fibers are protected from physical, chemical and mechanical effects. Furthermore, it is an object of an embodiment of the present invention to provide a cost-effective method for producing such a trim component and a means for transporting passengers with such a trim component.

This object is achieved with the features as set forth in the following paragraphs. Advantageous embodiments are also discussed.

An embodiment of the invention relates to a trim component for covering an interior space of a vehicle for transporting passengers, in particular a motor vehicle, wherein the trim component includes a pressed natural fiber composite element with at least one visible side perceptible from the interior space of the vehicle, which forms a natural fiber surface with a structure of natural fibers, and a protective varnish layer applied on the natural fiber surface and surrounding the natural fibers, which is designed so that the structure of natural fibers is perceptible by touch.

In particular, in contrast to the manner disclosed in EP 2 563 570 B1 for protecting the natural fibers from external influences, it is possible according to the invention to use a protective varnish layer. The protective varnish layer can be applied significantly more uniformly and with a significantly lower layer thickness than the multilayer protective layer which used, for example, in EP 2 563 570 B1. The volume of varnish needed to protect the natural fibers is significantly less than the volume needed for the multi-layered protective layer. In addition, the character of natural fibers is preserved to a much greater extent, especially with respect to optical and haptic properties. The protective varnish layer may be transparent, so that the color produced by the natural fibers remains visible. The protective varnish layer may be dyed to enhance the color of natural fibers. In order for the multilayer protective layer used in EP 2 563 570 B1 to adhere sufficiently to the natural fiber composite element, the multilayer protective layer must be of the same material as the natural fiber composite element. Such a limitation of the material is not required with the proposed protective varnish layer. The design options are thereby significantly increased. Furthermore, a very homogeneous appearance of the natural fiber surface can be achieved using the proposed protective varnish layer. Color variations and color adjustments can be more readily performed with the proposed protective varnish layer than with protective layers known from the prior art.

According to a further embodiment, the protective varnish layer is UV-resistant, abrasion-resistant, water-repellent and/or scratch-resistant. The external effects caused by UV rays, abrasion and moisture represent the greatest stress for natural fibers, which can be counteracted particularly effectively in this embodiment with the appropriately designed protective varnish layer.

In a further embodiment, the natural fiber composite element may have a binding matrix for the natural fibers made of a thermoplastic material, such as polypropylene (PP) or a thermosetting plastic. Such a binding matrix is widely used and enables the production of the trim component in a simple and cost-effective manner. Natural fiber composite elements made of polypropylene are also referred to as NFPP (natural fiber reinforced polypropylene). Examples of thermosetting plastics are epoxy resin, polyurethane resin and acrylic resin.

In a further embodiment, the natural fibers may be composed of sisal, hemp, jute, flax and/or the like, and may be made in the form of a needled or not-needled nonwoven fabric, a woven fabric or a unidirectional layer. The structure of the trim component including the protective varnish layer may have two or more layers. The proposed trim component can be made in various modifications, so that the interior space of the means for transporting passengers can be designed very differently, although the natural fibers encapsulated with the protective varnish layer are used in all variations.

An embodiment of the invention is directed to a method for producing a trim component according to one of the previously described embodiments, with the following steps:
Heating and calibrating the natural fiber composite panel or the natural fiber composite mat with a calibration tool,
Applying with an application device a protective varnish layer to a natural fiber composite panel or to a natural fiber composite mat,
Inserting the calibrated natural fiber composite panel or the calibrated natural fiber composite mat into a mold having an upper tool and a lower tool,
Closing the mold by moving the upper tool and/or the lower tool and reshaping the calibrated natural fiber composite panel or the calibrated natural fiber composite mat into a trim component, wherein
the step of reshaping takes place only after the protective varnish layer has been applied to the natural fiber composite panel or to the natural fiber composite mat.

Alternatively, the method may be configured as follows:
Applying with an application device a protective varnish layer onto a natural fiber composite panel or onto a natural fiber composite mat,
Heating and calibrating the natural fiber composite panel or the natural fiber composite mat with a calibration tool,
Inserting the calibrated natural fiber composite panel or the calibrated natural fiber composite mat into a mold having an upper tool and a lower tool,
Closing the mold by moving the upper tool and/or the lower tool and reshaping the calibrated natural fiber composite panel or the calibrated natural fiber composite mat to a trim component, wherein
the step of reshaping takes place after when the varnish protective coating has been applied to the natural fiber composite panel or to the natural fiber composite mat.

The technical effects and advantages that can be achieved with the proposed method are the same as those discussed for the present trim component. In summary, it should be noted that it is not necessary to use a multilayer protective layer to protect the natural fibers from external influences and effects. Rather, it is proposed to use a comparatively thin protective varnish layer, which leaves largely unaffected in particular the optical and haptic properties of natural fibers. In addition, the protective varnish layer can be applied very uniformly, thus producing a very homogeneous appearance of the natural fiber surface.

To bring the natural fiber composite panel or the natural fiber composite mat in the desired shape, it is first calibrated by supplying into the center of the material a large amount of heat as quickly as possible. For this purpose, the natural fiber composite panel or the natural fiber composite mat is heated and compressed. After calibration, the protective varnish layer is applied to the heated and calibrated natural fiber composite panel or the heated and calibrated natural fiber composite mat which is then placed in a mold having an upper tool and a lower tool. By closing the mold, the calibrated natural fiber composite panel or the calibrated natural fiber composite mat is formed into the desired shape. However, the protective varnish layer may also be applied on the natural fiber composite panel or natural fiber composite mat prior to calibration.

Because the protective varnish layer comes into contact with the heated natural fiber composite mat or the heated natural fiber composite panel, the varnish is also heated. As a result, components of the varnish base, for example, the solvents or water, evaporate at least partially before reshaping and thus do not affect the reshaping process.

In a further embodiment, the following step is contemplated:
Applying the protective varnish layer on the natural fiber composite panel or on the natural fiber composite mat by spraying using a spray applicator.

The use of a spray applicator as an application device is technically very easy to implement and ensures a uniform application of the protective varnish layer. In addition, spray applicators are particularly well suited to provide very thin protective varnish layers.

An advanced embodiment has the following step:
Applying the protective varnish layer on the natural fiber composite panel or on the natural fiber composite mat by layer transfer with a layer transfer device.

In this embodiment, the protective varnish layer is already completed before being applied to the natural fiber composite panel or the natural fiber composite mat. For this purpose, a suitably designed film is particularly suitable. The film also makes it possible to apply the protective varnish layer particularly homogeneously and with a small layer thickness to the natural fiber composite mat or the natural fiber composite panel. In contrast to the use of a spray applicator, this embodiment does not require providing a movable device for guiding the spray applicator across the natural fiber composite mat or natural fiber composite panel. In addition, the varnish need not be prepared so as to be sprayable. However, the varnish must be suitable to form a film. For example, the layer transfer device may include a number of rollers with which the film is applied to the natural fiber composite mat or natural fiber composite panel.

According to another embodiment, the following step is provided:
Applying the protective varnish layer on the upper tool and/or on the lower tool of the mold before the mold is closed for reshaping the calibrated natural fiber composite panel or the calibrated natural fiber composite mat into the trim component.

In this embodiment, the protective varnish layer is applied to the upper tool and/or the lower tool of the mold before it is closed for reshaping the calibrated and heated natural fiber composite panel or the calibrated and heated natural fiber composite mat. The protective varnish layer is located during manufacture exclusively in the mold, thus avoiding transporting the protective varnish layer together with the heated and calibrated natural fiber composite panel or the calibrated and heated natural fiber composite mat to the mold. This resulting external effects on the protective varnish layer, for example due to dust, are in this embodiment avoided or at least minimized, so that the resulting natural fiber surface can be made very homogeneous.

According to a further embodiment, the following step is provided:
Drying the natural fiber composite panel or the natural fiber composite mat with a drying device, after the protective varnish layer has been applied.

As mentioned, it is advantageous for providing a homogeneous natural fiber surface, if the components of the varnish base, for example the solvent or the water, already evaporate before the forming process, although these components already evaporate when the heat of the calibrated and heated natural fiber composite mat or the calibrated and heated natural fiber composite panel is transferred to the protective varnish layer. However, the heat is not always sufficient to completely evaporate these components. In order to nevertheless ensure that these components of the protective varnish layer evaporate as completely as possible, the drying step is used. The drying step can be carried out as soon as the protective varnish layer has been applied to the natural fiber composite mat or the natural fiber composite panel, i.e. even before calibration, depending on the design of the method.

In a further embodiment, the following additional step is provided:
With the mold closed, overmolding functional elements on the trim component.

Functional elements may be positioning pins, welding domes and the like, with which the trim component can be attached to adjoining attachments. These functional elements can be produced in the mold, thus eliminating an additional manufacturing step.

An embodiment of the invention relates to a means for transporting passengers, in particular a vehicle, with a trim component in particular according to one of the previously discussed embodiments for covering an interior space of the means for transporting passengers, wherein the trim component is manufactured by a method according to one of the previously discussed embodiments. The technical effects and advantages that can be achieved with the proposed means for transporting passengers correspond to those that have been discussed for the present trim component. In summary, it should be noted that it is not necessary to use a multilayer protective layer to protect the natural fibers from external influences and effects. Rather, with the described proposal, a comparatively thin protective varnish layer can be used, which leaves largely unaffected in particular the optical and haptic properties of natural fibers. In addition, the protective varnish layer can be applied very uniformly, thus creating a very homogeneous appearance of the natural fiber surface. A high-quality interior space of the means for transporting passengers can therefore be designed.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

Exemplary embodiments of the invention will be described in more detail below with reference to the accompanying drawings, which show in

FIG. 1A a schematic sectional view of an embodiment of a trim component according to the invention,

FIG. 1B the region A marked in FIG. 1A in an enlarged view, not to scale,

FIGS. 2A-2G various steps of a first embodiment of a method according to the invention for producing a trim component,

FIGS. 3A-3G various steps of a second embodiment of the method according to the invention for producing a trim component,

FIGS. 4A-4G various steps of a third embodiment of the method according to the invention for producing a trim component,

FIGS. 5A-5F various steps of a fourth embodiment of the method according to the invention for producing a trim component, and

FIG. 6 a plan view of a means for transporting passengers with such a trim component, each based on schematic diagrams.

### DETAILED DESCRIPTION OF PREFERRED EMBODIMENTS

Throughout all the Figures, same or corresponding elements are generally indicated by same reference numerals.

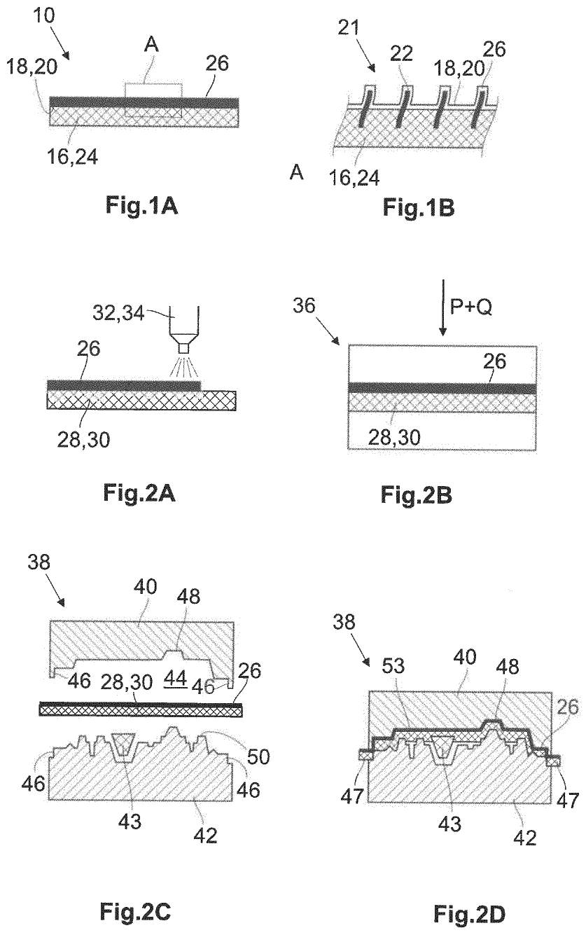

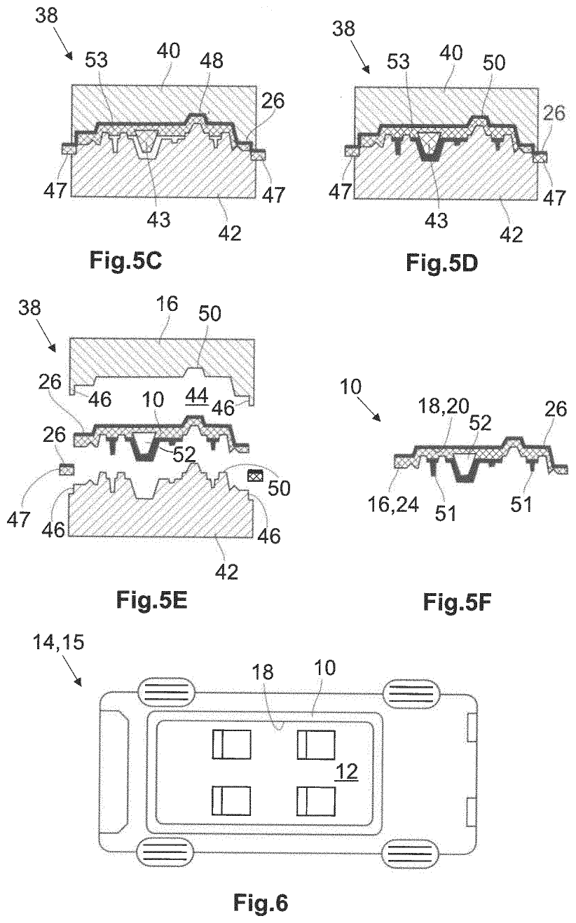

FIG. 1A shows a schematic sectional view through a trim component 10 according to the invention for covering an interior space 12 of a means for transporting passengers 14, in particular a vehicle 15 (see FIG. 6). FIG. 1B shows the region A marked in FIG. 1A in an enlarged diagram, not to scale. The trim component 10 has a pressed natural fiber composite element 16 with a visible side 18 on which a natural fiber surface 20 is arranged. The visible side 18 faces the interior space 12 in the installed state. The natural fiber surface 20 forms a structure 21 of natural fibers 22, which is perceptible from the interior space 12 of the means for transporting passengers 14 and which is in particular visible and tangible.

The trim component 10 has a binding matrix 24, which consists of a thermoplastic material such as polypropylene (PP) and in which the natural fibers 22 are anchored. The binding matrix 24 forms a layer of the trim component 10, wherein the structure of the natural fibers 22 is perceptible and/or tactile. The trim component 10 may have additional layers (not shown), for example to reinforce the trim component 10 or to decorate it with a design, for example with a natural fiber fabric or a natural fiber fleece.

As can be seen in particular from FIG. 1B, the proposed trim component 10 has a protective varnish layer 26, which is applied to the natural fiber surface 20 and which surrounds the natural fibers 22. The natural fibers 22 are therefore completely encapsulated by the protective varnish layer 26, so that although the structure 21 formed by the natural fibers 22 is preserved and can be felt by persons, the natural fibers 22 are nevertheless protected against external influences such as UV rays and/or mechanical stresses.

The natural fibers 22 may be made of, for example, sisal, hemp, jute, flax and/or the like, and may be produced in the form of a needled or non-needled nonwoven fabric, a woven fabric or a unidirectional layer and inserted in the binder matrix 24.

In the embodiment shown in FIGS. 1A and 1B, the natural fiber surface 20 extends over the entire visible side 18. However, it is also possible to exclude regions of the visible side 18 from the natural fiber surface 20, for example if a decorative element (not shown here) is to be arranged at that location.

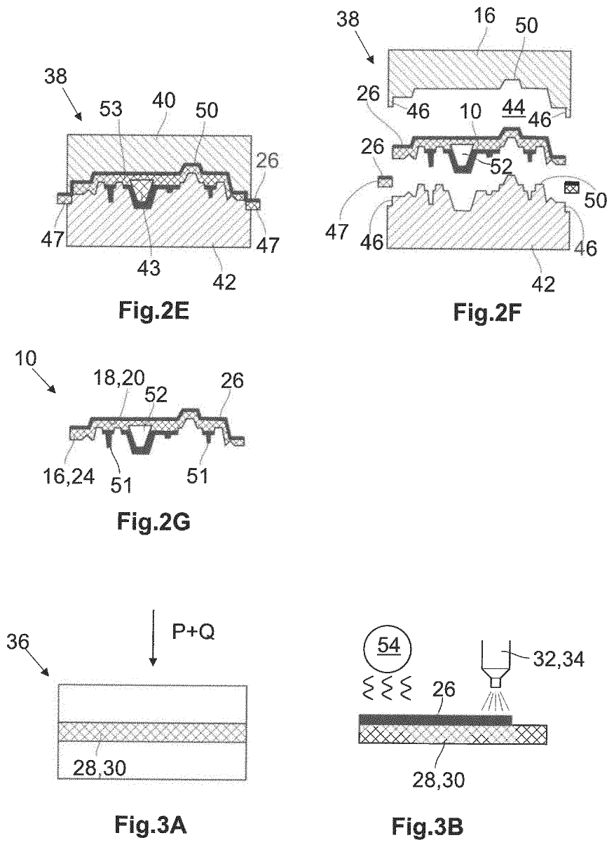

FIGS. 2A to 2G show a first exemplary embodiment of a method according to the invention for producing a trim component 10, for example as shown in FIGS. 1A and 1B. The starting material of the trim component 10 is formed by a natural fiber composite panel 28 or a natural fiber composite mat 30. As shown in FIG. 2A, the protective varnish layer 26 is applied to this natural fiber composite panel 28 or the natural fiber composite mat 30 with an applicator 32, in this case with a spray applicator 34, on the side 18 of the trim component 10 that is later visible. Once the protective varnish layer 26 has been applied over the entire side 18 that is later visible, the natural fiber composite panel 28 or the natural fiber composite mat 30 is calibrated with a calibration tool 36 (see FIG. 2B). During calibration, the natural fiber composite panel 28 or the natural fiber composite mat 30 is subjected to the pressure P. At the same time, the natural fiber composite mat 30 or the natural fiber composite panel 28 is heated with the heat Q. Due to the heating, at least part of the varnish base of the protective varnish layer 26, in particular solvent or water, evaporates.

Subsequently, the calibrated natural fiber composite panel 28 provided with the varnish protective layer 26 or the calibrated natural fiber composite mat 30 provided with the varnish protective layer 26 is placed in a mold 38 having an upper tool 40 and a lower tool 42. The upper tool 40 and the lower tool 42 can be moved towards and away from each other. As can be seen in FIG. 2C, in the opened state, the upper tool 40 and the lower tool 42 provide an unobstructed space 44, which is dimensioned such that the calibrated natural fiber composite panel 28 or the calibrated natural fiber composite mat 30 can be inserted into the mold 38.

The upper tool 40 and the lower tool 42 each have trimming edges 46. The calibrated natural fiber composite panel 28 or the calibrated natural fiber composite mat 30 is sized in the initial state so as to project outwardly beyond the trimming edges 46 when loaded into the mold 38.

After the calibrated natural fiber composite panel 28 or the calibrated natural fiber composite met 30 has been placed in the opened mold 38, the mold 38 is closed, as shown in FIG. 2D. For this purpose, the upper tool 40 and the lower tool 42 are moved towards each other. The closing of the mold 38 causes the calibrated natural fiber composite panel 28 or the calibrated natural fiber composite mat 30 to be first shaped into a shaped mat or panel 53. The trimming edges 46 cooperate in such a way that they separate upon closing edge pieces 47 from the calibrated natural fiber composite panel 28 or from the calibrated natural fiber composite mat 30.

The upper tool 40 and the lower tool 42 have recesses 48 and protrusions 50. Furthermore, the mold 38 has cores or sliders 43. The calibrated natural fiber composite panel 28 or the calibrated natural fiber composite mat 30 conforms to the profile of the recesses 48 and protrusions 50 if the recesses 48 are configured to contact the calibrated natural fiber composite panel 28 or the calibrated natural fiber composite mat 30 when the mold 38 is closed. Several of the recesses 48 of the lower tool 42 are designed so as to form a cavity when the mold 38 is dosed. The slider 43 can be inserted into this cavity. In the step illustrated in FIG. 2E, the cavities are filled with an injection molding material, so that functional elements 51 such as positioning and/or fastening sections or ribs can be overmolded or back-injected on the, in relation to FIGS. 2A to 2G, lower side of the reshaped mat or the reshaped panel 53. After the functional elements 51 have been completed, a trim component 10 is created.

As shown in FIG. 2F, the mold 38 is then opened and the slider 43 is retracted. The trim component 10 can now be removed from the mold 38. The edge pieces 47 are disposed of or recycled. FIG. 2G shows the trim component 10 with the overmolded functional elements 51. The respective functional element 51 has a hollow region 52 where the slider 43 was positioned.

By applying the protective varnish layer 26 prior to molding, the natural fibers 22 which tend to stand up due to the moisture can be pressed flat again so as to obtain a flat surface. The same advantage also applies to the embodiments of the method according to the invention to be described below.

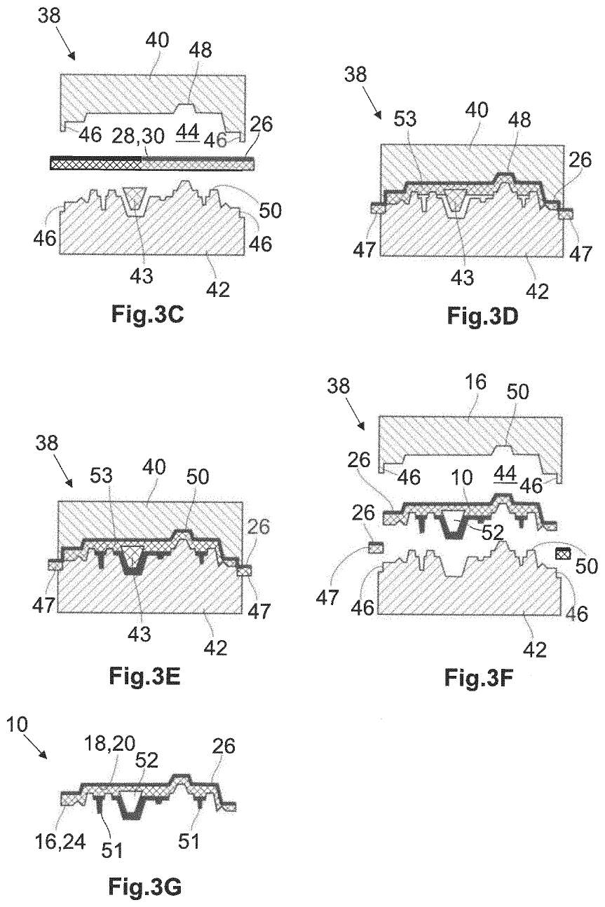

FIGS. 3A to 3G show a schematic diagram of a second exemplary embodiment of the method according to the invention. The second embodiment of the method according to the invention is largely identical to the first embodiment of the inventive method. However, the natural fiber composite panel 28 or the natural fiber composite mat 30 is first calibrated in the manner described above, before the protective varnish layer 26 is applied, which is once more done with a spray applicator 34 (see FIGS. 3A and 3B). As mentioned above, the natural fiber composite mat 30 or the natural fiber composite panel 28 is heated during calibration, so that the varnish base at least partially evaporates. In order to ensure that the varnish base evaporates completely or almost completely, the method according to the second embodiment includes the step of drying the already calibrated and heated natural fiber composite panel 28 or the heated and calibrated natural fiber composite panel 28 with a drying apparatus 54, for example with a hot air blower. The drying step may also be performed already prior to the calibration and after the protective varnish layer 26 has been applied. The remaining steps are similar to those discussed for the first embodiment of the method according to the invention.

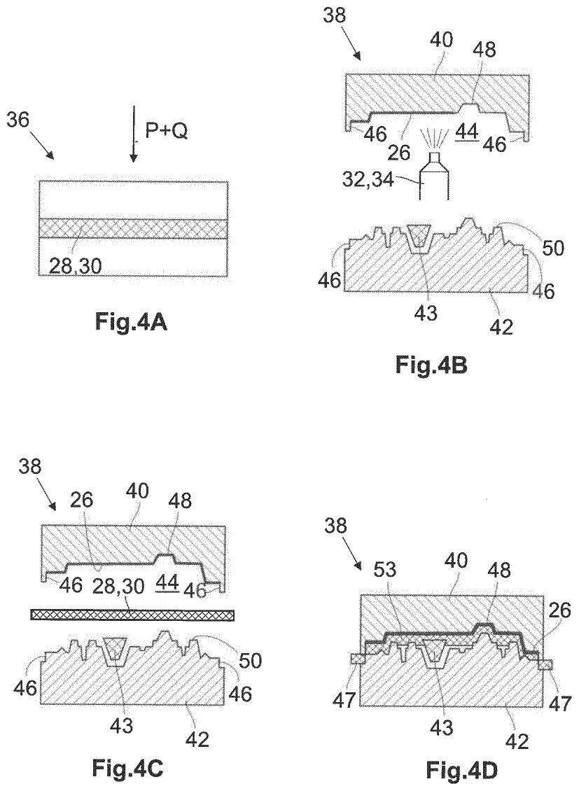

FIGS. 4A to 4G again show schematic diagrams of a third exemplary embodiment of the method according to the invention for producing the trim component 10. The essential difference to the method according to the first and the second embodiment is that the protective varnish layer 26 is applied in this case on the upper tool 40 of the mold 38 using the afore-described spray applicator 34 (FIG. 4B). The upper tool 40 hereby forms the side 18 of the trim component 10 that is later visible. The calibrated natural fiber mat 30 or the calibrated natural fiber composite panel 28 (FIG. 4A) is inserted in the mold 38 after the varnish protective layer 26 has been applied to the upper mold 40 (see FIG. 4C). The remaining steps shown in FIGS. 4D to 4G correspond to the steps of the method according to the first and second embodiments. It should be noted that in the method according to the third embodiment, the protective varnish layer 26 can be applied so as not to extend to the edge pieces 47 which are formed when the mold 38 closes. The edge pieces 47 separated from the trim component 10 can then be more easily disposed of. In addition, the amount of varnish needed can be reduced to just the required quantity.

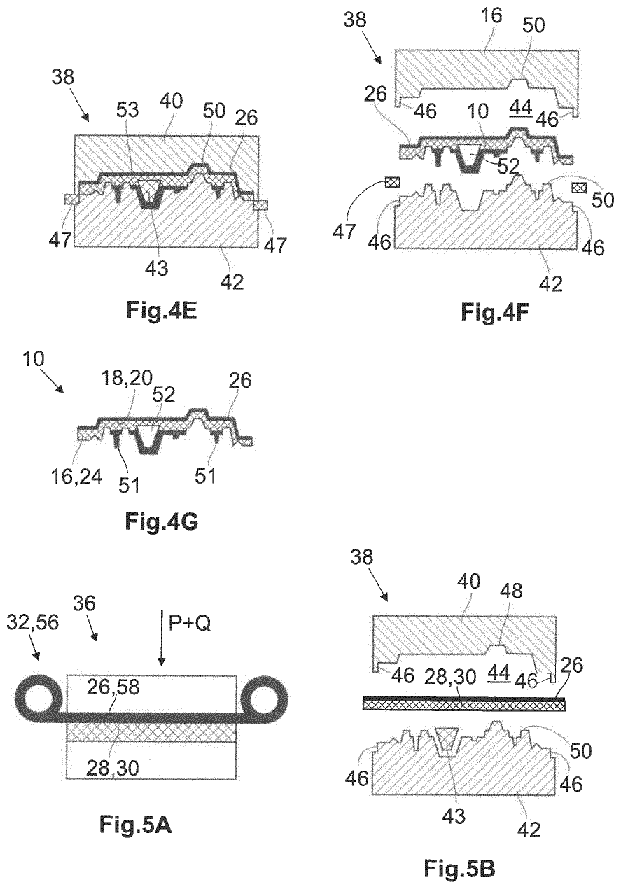

FIGS. 5A to 5F show schematic diagrams of a fourth embodiment of the method according to the invention. In this case, the protective varnish layer 26 is applied on the side 18 of the trim component 10 that is later visible not with a spray applicator 34, but rather with a layer transfer device 56, which in this case forms the application device 32. The protective varnish layer 26 is provided as a continuous film 58 which is applied with the layer transfer device 56 to the natural fiber composite mat 30 or the natural fiber composite panel 28. As shown in FIG. 5A, the layer transfer device 56 can be integrated into the calibration tool 36, so that the steps of applying the protective varnish layer 26 and the calibration can be performed almost simultaneously at the same location. The calibrated natural fiber composite mat 30 or the calibrated natural fiber composite panel 28 is now inserted into the open mold 38, as shown in FIG. 5B. The following steps correspond to those already illustrated for the other embodiments of the method according to the invention.

In FIG. 6 shows a means for transporting passengers 14 designed as a vehicle 15. The vehicle 15 has an interior space 12, which is covered with a trim component 10 according to the invention. The visible side 18 of the trim component 10 faces the interior space 12.

While the invention has been illustrated and described as embodied in a trim component for covering an interior space of a means for transporting passengers as well as method for producing such a trim component, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A trim component for covering an interior space of a passenger transport vehicle comprising:
a pressed natural fiber composite element having at least one visible side perceptible from the interior space of the passenger transport vehicle, said pressed natural fiber composite element forms a natural fiber surface with a structure of individual natural fibers, and
a protective varnish layer applied to the natural fiber surface so that the natural fibers are surrounded by varnish, such that the structure of the natural fibers can be perceived by touch.

2. The trim component according to claim 1, wherein the protective varnish layer is UV-resistant, abrasion-resistant, water-repellent and/or scratch-resistant.

3. The trim component according to claim 1, wherein the natural fiber composite element comprises a binding matrix for the natural fibers made of a thermoplastic material or of a thermosetting plastic material.

4. The trim component according to claim 2, wherein the natural fibers are selected from material of the group consisting of sisal, hemp, jute, flax and fibers in the same plant genus, and are constructed in the form of a needled or non-needled nonwoven fabric, or a woven fabric or a unidirectional layer.

5. A method for producing a trim component according to claim 1, comprising the following steps:
Heating and calibrating the natural fiber composite element in form of a natural fiber composite panel or a natural fiber composite mat with a calibration tool,
applying a protective varnish layer onto the natural fiber composite panel or natural fiber composite mat with an application device,
inserting the heated and calibrated natural fiber composite panel or natural fiber composite mat into a mold having an upper tool and a lower tool,
closing the mold by moving the upper tool and/or the lower tool and reshaping the heated and calibrated natural fiber composite panel or natural fiber composite mat into a trim component, wherein
the step of reshaping takes place only after the protective varnish layer has been applied onto the natural fiber composite panel or natural fiber composite mat.

6. A method of manufacturing a trim component according to claim 4, comprising the following steps:
Heating and calibrating the fiber composite element in form of a natural fiber composite panel or in form of a natural fiber composite mat with a calibration tool,
applying a protective varnish layer onto the natural fiber composite panel or natural fiber composite mat with an application device,
inserting the heated and calibrated natural fiber composite panel or natural fiber composite mat into a mold having an upper tool and a lower tool,
closing the mold by moving the upper tool and/or the lower tool and reshaping the heated and calibrated natural fiber composite panel or natural fiber composite mat into a trim component, wherein
the step of reshaping takes place only after the protective varnish layer has been applied onto the natural fiber composite panel or natural fiber composite mat.

7. The method according to claim 5, further comprising the following step:
Applying the protective varnish layer onto the natural fiber composite panel or the natural fiber composite mat by spraying using a spray applicator.

8. The method according to claim 5, further comprising the following step:
Applying the protective varnish layer onto the natural fiber composite panel or the natural fiber composite mat by layer transfer using a layer transfer device.

9. The method according to claim 5, further comprising the following step:
Applying the protective varnish layer onto the upper tool and/or onto the lower tool of the mold before the mold is closed, for reshaping the calibrated and heated natural fiber composite panel or natural fiber composite mat into the trim component.

10. The method according to claim 5, further comprising the following step:
Drying the natural fiber composite panel or the natural fiber composite mat with a drying device after the protective varnish layer has been applied.

11. The method according to claim 5, further comprising the following step:
Overmolding functional elements on the trim component with the mold closed, said functional elements comprising positioning pins and welding domes.

12. A vehicle for transporting passengers, said vehicle provided with a trim component for covering an interior space of the vehicle, wherein the trim component is produced by a method according to claim 5.

13. The trim component for covering an interior space of a passenger transport vehicle according to claim 3, wherein the thermoplastic material is polypropylene (PP).
